(19) United States
(12) Patent Application Publication
(10) Pub. No.: US 2026/0084485 A1
(43) Pub. Date: Mar. 26, 2026

(54) VEHICULAR INDOOR TEMPERATURE SENSOR

(71) Applicants: Hanon Systems, Daejeon (KR); AMPHENOL SENSING KOREA LTD., Gyeonggi-do (KR)

(72) Inventors: Chaegeun LIM, Daejeon (KR); Young Chul KIM, Daejeon (KR); Changhyun BAEK, Daejeon (KR); Sang Ho OH, Daejeon (KR); Yun Sung JO, Daejeon (KR); Yongnam SEO, Gyeonggi-do (KR); Su-Hyun KIM, Gyeonggi-do (KR)

(73) Assignees: Hanon Systems, Daejeon (KR); AMPHENOL SENSING KOREA LTD., Gyeonggi-do (KR)

(21) Appl. No.: 19/109,549

(22) PCT Filed: Sep. 26, 2023
(86) PCT No.: PCT/KR2023/014905

§ 371 Date: Mar. 6, 2025

(30) Foreign Application Priority Data
Oct. 7, 2022 (KR) 10-2022-0128319

(51) Int. Cl. B60H 1/00; G01K 1/14; G01K 1/20

(52) U.S. Cl. CPC B60H 1/00807; B60H 1/0075; G01K 1/14; G01K 1/20

(57) ABSTRACT

A vehicular indoor temperature sensor is disclosed, which includes: a PCB substrate; a tip sensor unit connected to a front side of the PCB substrate, and which includes a first temperature sensor for detecting the temperature of the outer surface of one side of a tip housing, and a solar radiation sensor for sensing the amount of solar radiation incident on the outer surface of the one side of the tip housing; and a sensor housing, which accommodates at least a portion of the tip sensor unit and at least a portion of the PCB substrate so as to prevent foreign substances from flowing into the PCB substrate from the outside, wherein the lower side of the top of the sensor housing has a cut portion which enables foreign substances flowing in between the tip housing and the sensor housing to be discharged at the lower side.

### DESCRIPTION

### Technical Field

The present invention relates to a vehicular indoor temperature sensor and, more specifically, to a vehicular indoor temperature sensor, which smoothly discharges moist foreign substances flowing into a sensor housing from the outside through a cut portion of the sensor housing, and increases the air contact area of a tip sensor unit so that the sensitivity of temperature sensing can be improved.

### Background Art

Vehicular indoor temperature sensors may be divided into air-breathing indoor temperature sensors that measure the temperature of flowing air by taking in air inside a vehicle into a sensor, and non-air-breathing indoor temperature sensors that measure a vehicular indoor temperature without taking in air.

The air-breathing indoor temperature sensors are advantageous in that measured temperature is highly reliable and sensing logic is relatively simple since the sensors themselves take in the air inside the vehicle and measure the temperature of the taken-in air. However, the sensors are disadvantageous in that the appearance requires a grill shape to take in air into the sensor, and cost competitiveness is low as a flow generation device for flowing air is required.

In comparison thereto, the non-air-breathing indoor temperature sensors are advantageous in that they may be configured to have a high degree of freedom and a beautiful appearance in the external appearance as a grill shape is not required, and cost competitiveness is relatively high.

FIG. 1 is a view showing a conventional vehicular indoor temperature sensor.

As shown in FIG. 1, the non-air-breathing indoor temperature sensor like this is configured to include a tip sensor unit 1 in which an IR sensor for measuring temperature and a photo sensor for sensing light are packaged together, a PCB 2 on which an NTC, which is a temperature sensor provided to compensate for the difference of temperature between the IR sensor of the tip sensor unit 1 and a PCB portion, is mounted, and a cover housing 3 for accommodating at least a portion of the PCB 2 to protect elements including the NTC of the PCB 2 from foreign substances entering from the outside.

Here, the cover housing 3 is made of a plastic or resin material to tightly seal and protect a predetermined portion of the PCB 2 elements and the tip sensor unit 1. Accordingly, the IR sensor of the tip sensor unit 1 and the NTC are isolated from the outdoor air by the sealing structure of the cover housing 3 and may not be in direct contact with the surrounding temperature.

Due to the sealing structure like this, there is a problem in that the time of the IR sensor and the NTC, which are temperature sensors, responding to a change in the surrounding temperature is delayed, and it is difficult for a user to immediately control a desired temperature due to the delayed response time.

### DISCLOSURE

### Technical Problem

The present invention has been made to solve the above problems, and an object of the present invention is to provide a vehicular indoor temperature sensor, which smoothly discharges moist foreign substances flowing into a sensor housing from the outside through a cut portion of the sensor housing, and increases the air contact area of a tip sensor unit so that the sensitivity of temperature sensing can be improved.

In addition, another object of the present invention is to provide a vehicular indoor temperature sensor, which can improve the response speed of a second temperature sensor on a PCB substrate and protect the PCB substrate from flowing-in moisture by removing an injection material protecting the PCB substrate and forming a conformal coating layer on the PCB substrate.

### Technical Solution

The present invention has the following features to solve the problems described above.

The present invention provides a vehicular indoor temperature sensor comprising: a PCB substrate; a tip sensor unit connected to a front side of the PCB substrate and including a first temperature sensor for detecting a temperature of the outer surface of one side of a tip housing, and a solar radiation sensor for sensing an amount of solar radiation incident on the outer surface of the one side of the tip housing; and a sensor housing that accommodates at least a portion of the tip sensor unit and at least a portion of the PCB substrate to prevent foreign substances from flowing into the PCB substrate from the outside, wherein the lower side of the top of the sensor housing has a cut portion which enables foreign substances flowing in between the tip housing and the sensor housing to be discharged at the lower side, and which increases an air contact area of the tip sensor unit.

Here, the tip sensor unit includes the first temperature sensor, the solar radiation sensor, and the tip housing that accommodates a portion of the first temperature sensor and a portion of the solar radiation sensor located on a front side of the PCB substrate, wherein the tip housing includes a front body of a cylindrical shape and a rear body formed to have a diameter larger than a diameter of the front body.

In addition, the cut portion is formed by cutting a front-end lower portion of the sensor housing, which faces a lower end portion of the rear body of the tip housing.

In addition, a front-end unit of the sensor housing is formed in a cylindrical shape with open top and bottom portions to accommodate a predetermined portion of the tip housing and is disposed to face the tip housing, wherein at least one protrusion protruding toward inside of the front-end unit is formed on an inner wall surface of the front-end unit along a length direction of the sensor housing to separate the rear body of the tip housing from the inner wall surface of the front-end unit.

In addition, the cut portion is formed in a ‘U’ shape, and a width is formed to be ⅕ to ½ of a diameter of the front-end unit of the sensor housing.

In addition, the cut portion is formed to be larger than the front-end lower portion of the sensor housing facing the lower end portion of the rear body of the tip housing, toward a center along the length direction.

In addition, the vehicular indoor temperature sensor further comprises a second temperature sensor installed on the PCB substrate to sense temperature and compensate for a difference of temperature between the tip sensor unit and the PCB substrate.

In addition, the front-end lower portion of the sensor housing, where the cut portion is formed, includes a lowest point in a direction of gravity, at a front end of the sensor housing when the sensor housing is disposed.

Meanwhile, a vehicular indoor temperature sensor according to another embodiment of the present invention comprises: a PCB substrate; and a tip sensor unit connected to a front side of the PCB substrate and including a first temperature sensor for detecting a temperature of the outer surface of one side of a tip housing, and a solar radiation sensor for sensing an amount of solar radiation incident on the outer surface of the one side of the tip housing, wherein a second temperature sensor for compensating for a difference of temperature between the tip sensor unit and the PCB substrate is installed on the PCB substrate.

Here, a conformal coating layer is formed on at least a portion of the PCB substrate to prevent infiltration of flowing-in moisture.

### Advantageous Effects

According to the present invention, there is an effect of smoothly discharging moist foreign substances flowing into a sensor housing from the outside through a cut portion of the sensor housing, and increasing the air contact area of a tip sensor unit so that the sensitivity of temperature sensing can be improved.

In addition, as a cut portion is formed to be close to the central portion compared to the rear body of the tip housing, and a first communication portion, through which outdoor air may flow into the sensor housing, is formed, there is an effect of improving the response speed of a second temperature sensor installed on the PCB substrate inside the sensor housing, and preventing occurrence of dew condensation by reducing the difference of temperature between the inside and the outside of the sensor housing.

In addition, as an injection material protecting the PCB substrate is removed and a conformal coating layer is formed on the PCB substrate, there is an effect improving the response speed of the second temperature sensor on the PCB substrate, and protecting the PCB substrate from flowing-in moisture.

### DESCRIPTION OF DRAWINGS

FIG. 1 is a view showing a conventional vehicular indoor temperature sensor.

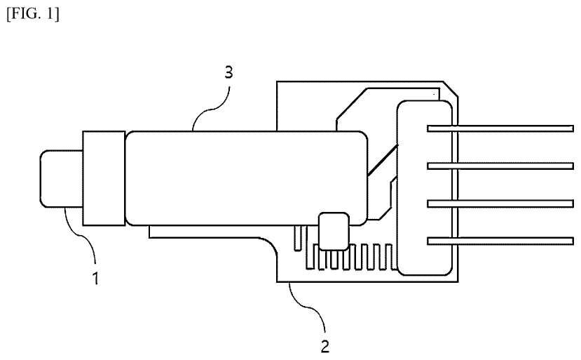

FIG. 2 is a bottom perspective view showing a vehicular indoor temperature sensor according to an embodiment of the present invention.

FIG. 3 is an enlarged view showing portion A of FIG. 2.

FIG. 4 is a cross-sectional view taken along line B-B′ in FIG. 2, which is a vertical cross-sectional view in a state where an indoor temperature sensor according to an embodiment of the present invention is installed.

FIG. 5 is an enlarged view showing portion C of FIG. 4.

FIG. 6 is a front view seen from the front end in FIG. 4.

FIG. 7 is a view showing a sensing information transmission process of an indoor temperature sensor according to an embodiment of the present invention.

FIG. 8 is a view showing a vehicular indoor temperature sensor according to another embodiment of the present invention.

### MODE FOR INVENTION

In order to describe the present invention, the operational advantages of the present invention, and the objects achieved by implementing the present invention, preferred embodiments of the present invention will be exemplified and described with reference thereto.

First, the terms used in this application are only used to describe specific embodiments, and are not intended to limit the present invention, and singular expressions may include plural expressions unless the context clearly indicates otherwise. In addition, in this application, it should be understood that the terms such as “comprise”, “have”, and the like are intended to specify the presence of a feature, a number, a step, an operation, a component, a part, or a combination thereof described in the specification, and do not exclude in advance the possibility of the presence or addition of one or more other features, numbers, steps, operations, components, parts or combinations thereof.

In describing the present invention, when it is determined that a detailed description of a related known configuration or function may obscure the gist of the present invention, the detailed description will be omitted.

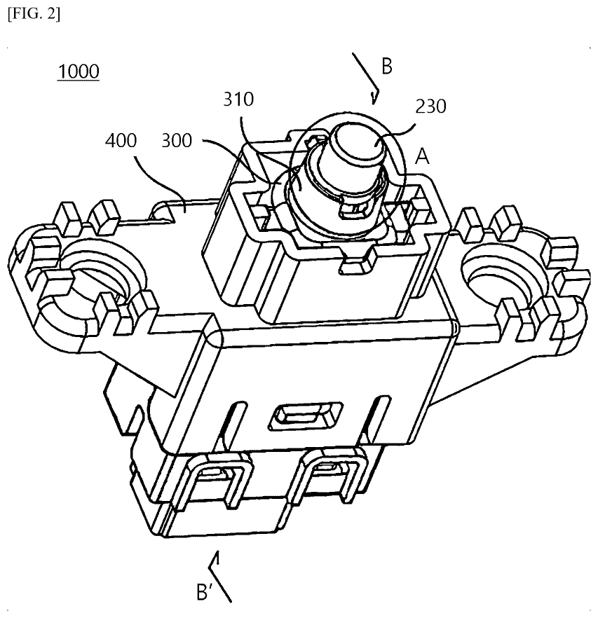

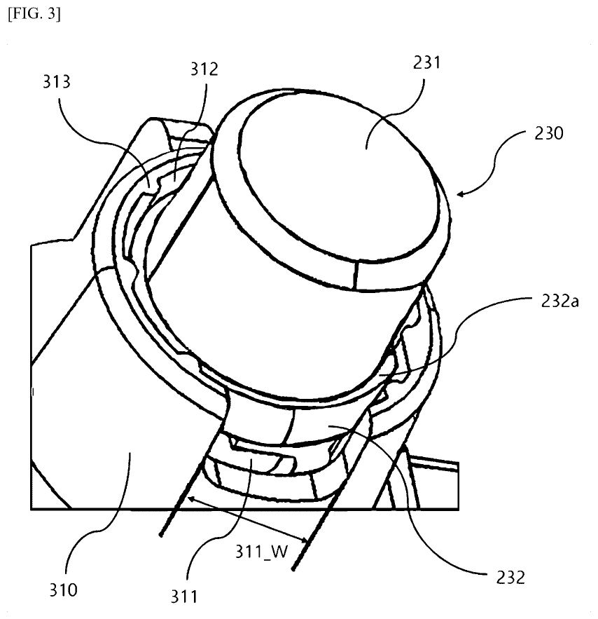

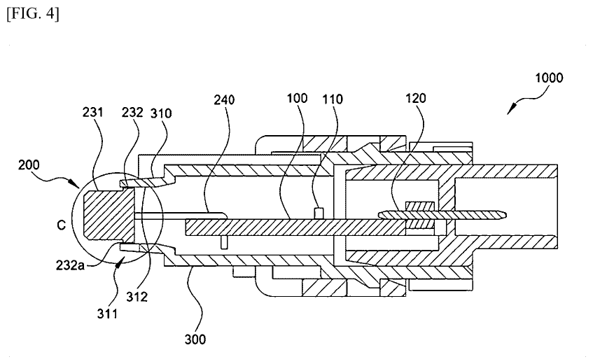

FIG. 2 is a bottom perspective view showing a vehicular indoor temperature sensor according to an embodiment of the present invention, FIG. 3 is an enlarged view showing portion A of FIG. 2, and FIG. 4 is a cross-sectional view taken along line B-B′ in FIG. 2, which is a vertical cross-sectional view in a state where an indoor temperature sensor according to an embodiment of the present invention is installed.

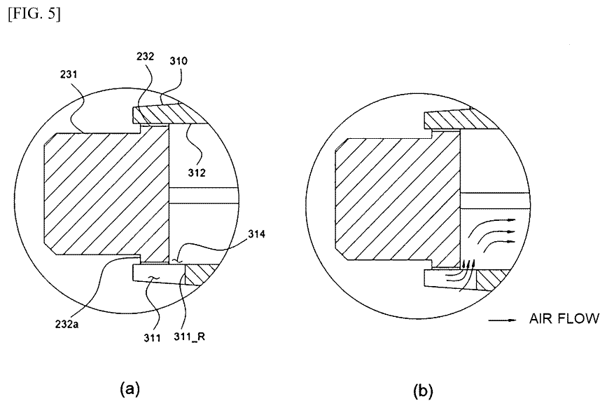

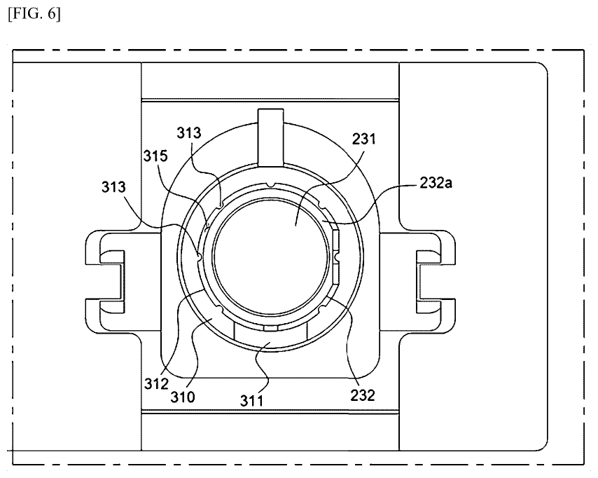

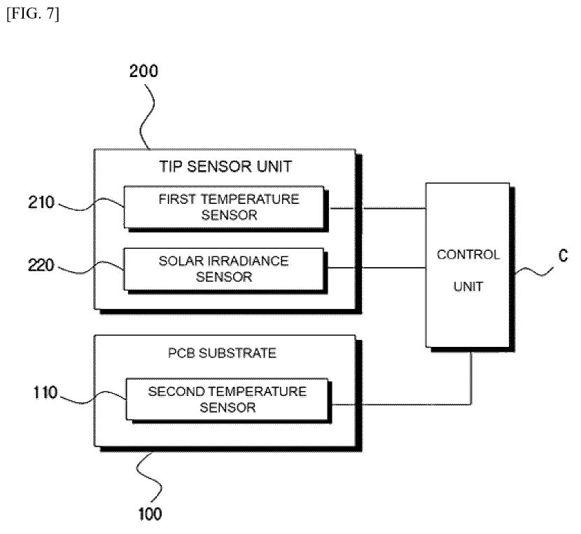

In addition, FIG. 5 is an enlarged view showing portion C of FIG. 4, FIG. 6 is a front view seen from the front end in FIG. 4, and FIG. 7 is a view showing a sensing information transmission process of an indoor temperature sensor according to an embodiment of the present invention.

Referring to the drawings, a vehicular indoor temperature sensor 1000 according to an embodiment of the present invention largely includes a PCB substrate 100, a tip sensor unit 200 connected to the front side of the PCB substrate 100 and including a first temperature sensor for detecting the temperature of the outer surface of one side of a tip housing, and a solar radiation sensor for sensing an amount of solar radiation incident on the outer surface of the one side of the tip housing, and a sensor housing 300 that accommodates at least a portion of the tip sensor unit 200 and the PCB substrate 100 to prevent foreign substances from flowing in from the outside.

Here, the PCB substrate 100 is configured to be connected to the tip sensor unit 200 and a connector unit 240 on the front side to receive the outdoor temperature measured by the tip sensor unit 200, i.e., the indoor temperature and information on the amount of solar radiation of the vehicle, and is provided with a second temperature sensor 110 installed on the PCB substrate to compensate for the difference of temperature between the tip sensor unit 200 and the PCB substrate 100 and sense the temperature.

A connection pin unit 120 for transmitting sensing information measured by the tip sensor unit 200 and the second temperature sensor 110 to the internal system of the vehicle may be installed on the rear portion of the PCB substrate 100.

Meanwhile, the tip sensor unit 200 is provided to be positioned on the front side of the PCB substrate 100 as described above to sense the indoor temperature of the vehicle and information on the amount of indoor solar radiation of the vehicle. The tip sensor unit 200 includes a first temperature sensor 210 for detecting the indoor temperature of the vehicle, a solar radiation sensor 220 for sensing information on the amount of indoor solar radiation of the vehicle, a tip housing 230 for accommodating a portion of the first temperature sensor 210 and a portion of the solar radiation sensor 220 located on the front side of the PCB substrate 100, and a connector unit 240 that is a connection unit through which the first temperature sensor 210 and the solar radiation sensor 220 are connected to the PCB substrate 100 so that the sensing information is transmitted to the PCB substrate 100.

Here, the tip housing 230 is configured of a front body 231 of a cylindrical shape and a rear body 232 formed to have a diameter larger than that of the front body 231. At this point, as the rear body 232 is formed to have an interference surface 232a extended outward more than the front body 231, moist foreign substances flowing in between the tip housing 230 and the front-end unit of the sensor housing 300, which will be described below, collide with the interference surface 232a and move toward the lower portion along the interference surface 232a.

That is, a discharge function is performed to guide foreign substances, such as moisture and the like flowing in through the interference surface 232a of the rear body 232, to the lower portion and discharge the foreign substances to the outside through a cut portion 311 of the sensor housing 300.

Meanwhile, the sensor housing 300 is provided to accommodate at least a portion of the tip sensor unit 200 and the PCB substrate 100 to prevent foreign substances from flowing in from the outside. It is preferable that the front-end unit 310 of the sensor housing 300 is formed in a cylindrical shape with open top and bottom portions to accommodate a predetermined portion of the tip housing 230, and the cut portion 311 is formed as described above.

Here, the cut portion 311 is formed at the lower portion of the front-end unit 310 of the sensor housing 300, and is formed by cutting the lower portion of the front-end unit 310 of the sensor housing 300, which faces a lower end portion of the rear body 232 of the tip housing 230.

The reason why such a cut portion 311 is formed at the lower portion of the front-end unit 310 of the sensor housing 300, i.e., at the lower portion in the direction of gravity from the front end of the sensor housing 300 when the sensor housing 300 is disposed, is to allow moist foreign substances flowing in between the tip housing 230 and the sensor housing 300 to move toward the lower portion along the interference surface 232a of the rear body 232 by gravity and then be discharged to the outside through the cut portion 311 of the sensor housing 300.

In addition to discharging the foreign substances that flow in between the tip housing 230 and the front-end unit 310 of the sensor housing, this cut portion 311 may increase sensing sensitivity of the tip sensor unit 200 by increasing the area of the tip housing 230 in contact with the outdoor air.

In addition, as the cut portion 311 is formed as shown in FIG. 5, a first communication portion 314, which is a space that connects the outside and the inside of the sensor housing 300, is also formed.

As the outdoor air may easily flow into the sensor housing 300 through the first communication portion, the second temperature sensor 110 of the PCB substrate 100 located inside the sensor housing 300 may exhibit a higher response sensitivity to the change in the temperature of the outdoor air, compared to existing sealed-type indoor temperature sensors.

In addition, in the case of an existing sealed-type indoor temperature sensor, when the difference between the temperature inside the sensor housing 300 and the temperature outside the sensor housing 300 is significant, dew condensation may occur due to condensation of air. However, in the present invention, as air may communicate between the inside and the outside of the sensor housing 300 through the cut portion 311 and the first communication portion 314, difference in the temperature is reduced, and dew condensation can be prevented or minimized.

It is preferable to form the cut portion 311 in a ‘U’ shape, and the width 311_W of the cut portion is preferably formed to be ⅕ to ½ of the diameter of the front-end unit 310 of the sensor housing as shown in FIG. 2.

When the width 311_W of the cut portion is too large, as foreign substances may flow into the sensor housing 300 through the cut portion 311, the effect of blocking foreign substances may be lowered. When it is too small, as foreign substances guided along the interference surface 232a of the tip housing 230 may not be smoothly discharged to the outside as described above and may flow into the inside, a problem may occur.

In addition, there is also a problem in that as the size of the area in contact with the outdoor air is small, the range of increase in the sensing sensitivity of the tip sensor unit 200 is reduced.

In addition, it is preferable that the cut portion 311 is formed to be larger than the lower point of the front-end unit 310 of the sensor housing 300 facing the lower end portion of the rear body 232 of the tip housing 230, toward the center along the length direction of the sensor housing 300.

That is, as shown in FIG. 5(a), the depth of the cut portion 311, i.e., the rightmost point 311_R of the cut portion, should be positioned closer to the center than the rear body 232 to completely discharge foreign substances guided along the interference surface 232a of the rear body 232 and also form the first communication portion 314 described above.

Accordingly, as shown in FIG. 5(b), outdoor air may flow into the sensor housing 300, and as described above, the effect of improving the sensing sensitivity of the second temperature sensor 110 and preventing dew condensation occurring at the front end of the sensor housing 300 according to the air flow can be induced.

Meanwhile, as shown in FIG. 6, the inner wall surface 312 of the front-end unit 310 of the sensor housing 300 is disposed to be spaced apart from and face the tip housing 230 by a predetermined distance, and the inner wall surface 312 of the front-end unit 310 is disposed to be in contact with or to be spaced apart from the rear body 232 of the tip housing 230 by a predetermined distance.

Here, a plurality of protrusions 313 is formed on the inner wall surface 312 to separate the tip housing 230 from the sensor housing 300 so that outdoor air may flow into the sensor housing 300.

Here, the protrusions 313 are formed to protrude as much as a predetermined length in the longitudinal direction of the sensor housing 300, and the plurality of protrusions is formed to be spaced apart from each other along the circumference of the inner wall surface 312.

Accordingly, as the rear body 232 is fundamentally blocked not to contact the inner wall surface 312 of the sensor housing front-end unit 310, a second communication portion 315, which is a communication space through which the outdoor air may flow into the sensor housing, is formed.

As the second communication portion 315 is formed through the protrusions 313 like the first communication portion 314 described above, temperature sensing sensitivity of the second temperature sensor 110 installed on the PCB substrate 100 can be improved, and dew condensation occurring due to condensation can be prevented by reducing the difference of temperature between the inside and the outside of the sensor housing front-end unit 310.

Meanwhile, the fixed bracket 400 shown in FIGS. 2 and 4 is a housing that allows the indoor temperature sensor 1000 of the present invention to be fixedly connected to a dashboard or the like of a vehicle, and may be configured in various shapes according to the assembly shape.

In addition, as shown in FIG. 7, the first temperature sensor 210 and the solar radiation sensor 220 of the tip sensor unit 200 according to an embodiment of the present invention detect the temperature and amount of solar radiation of one side surface of the tip housing 230 and transmit the sensing information to a separate control unit C connected by the connection pin unit 120, and the second temperature sensor 110 installed on the PCB substrate 100 also detects the temperature on the PCB substrate and transmits the sensing information to the control unit C.

Accordingly, the control unit C may determine the indoor temperature of the vehicle more accurately.

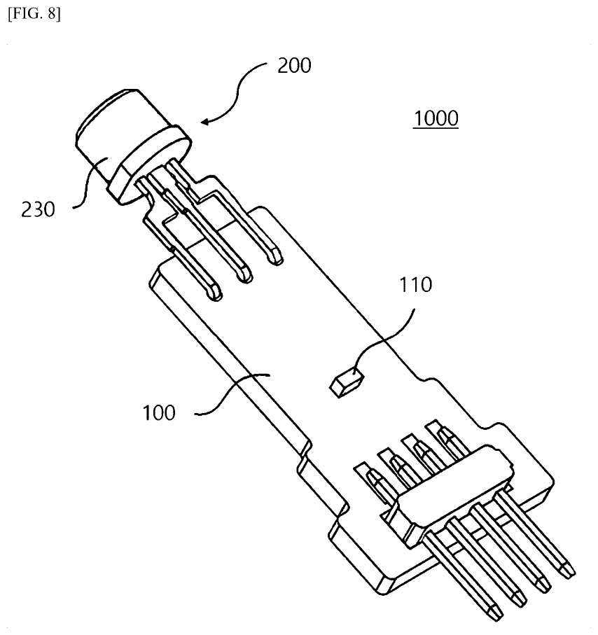

FIG. 8 is a view showing a vehicular indoor temperature sensor according to another embodiment of the present invention.

Referring to the drawing, the vehicular indoor temperature sensor 1000 according to the present embodiment includes a PCB substrate 100, and a tip sensor unit 200 that is connected the front side of the PCB substrate 100 and includes a first temperature sensor 210 for detecting the temperature of the outer surface of one side of the tip housing 230, and a solar radiation sensor 220 for sensing an amount of solar radiation incident on the outer surface of the one side of the tip housing 230.

Unlike the embodiment described above, the indoor temperature sensor 1000 according to this embodiment omits the sensor housing 300, and accordingly, the tip sensor unit 200 is in contact with the outdoor air across the entire surface, and as the second temperature sensor 110 on the PCB substrate 100 is also exposed to be in contact with the outdoor air, it may exhibit a high response speed to the change in the outdoor temperature.

However, as the sensor housing 300 in the embodiment described above is omitted, a conformal coating layer is formed on at least a portion of the PCB substrate 100 so that various components on the PCB substrate 100 may not be damaged by moist foreign substances flowing into the PCB substrate 100 from the outside.

Here, conformal coating is generally applied to a printed circuit board (PCB) or other electronic components to generate a thin protection polymer layer to protect them from particles, moisture, gases, and other contaminants or corrosive materials, and examples of a conformal coating agent include ECC3011 and ECC3051S silicone conformal coating agents of Momentive.

Accordingly, corrosion of PCB components mounted on the PCB substrate 100 and the surface of the PCB substrate can be prevented.

Although preferred embodiments of the present invention have been described above, the present invention is not limited to the specific embodiments described above. That is, those skilled in the art may make various changes and modifications to the present invention without departing from the spirit and scope of the appended claims, and all such appropriate changes and modifications are equivalents and should be regarded as falling within the scope of the present invention.

### DESCRIPTION OF REFERENCE NUMERALS

100: PCB substrate
110: Second temperature sensor
120: Connection pin unit
200: Tip sensor unit
210: First temperature sensor
220: Solar radiation sensor
230: Tip housing
231: Front body
232: Rear body
232a: Interference surface
240: Connector unit
300: Sensor housing
310: Front-end unit
311: Cut portion
311_W: Width of cut portion
311_R: Rightmost point of cut portion
312: Inner wall surface
313: Protrusion
314: First communication portion
315: Second communication portion
400: Fixed bracket
1000: Indoor temperature sensor

1. A vehicular indoor temperature sensor comprising:
a PCB substrate;
a tip sensor unit connected to a front side of the PCB substrate and including a first temperature sensor for detecting a temperature of the outer surface of one side of a tip housing, and a solar radiation sensor for sensing an amount of solar radiation incident on the outer surface of the one side of the tip housing; and
a sensor housing that accommodates at least a portion of the tip sensor unit and at least a portion of the PCB substrate to prevent foreign substances from flowing into the PCB substrate from the outside, wherein
the lower side of the top of the sensor housing has a cut portion which enables foreign substances flowing in between the tip housing and the sensor housing to be discharged at the lower side, and which increases an air contact area of the tip sensor unit.

2. The vehicular indoor temperature sensor according to claim 1, wherein the tip sensor unit includes the first temperature sensor, the solar radiation sensor, and the tip housing that accommodates a portion of the first temperature sensor and a portion of the solar radiation sensor located on a front side of the PCB substrate, wherein the tip housing includes a front body of a cylindrical shape and a rear body formed to have a diameter larger than a diameter of the front body.

3. The vehicular indoor temperature sensor according to claim 2, wherein the cut portion is formed by cutting a front-end lower portion of the sensor housing, which faces a lower end portion of the rear body of the tip housing.

4. The vehicular indoor temperature sensor according to claim 3, wherein a front-end unit of the sensor housing is formed in a cylindrical shape with open top and bottom portions to accommodate a predetermined portion of the tip housing and is disposed to face the tip housing, wherein at least one protrusion protruding toward inside of the front-end unit is formed on an inner wall surface of the front-end unit along a length direction of the sensor housing to separate the rear body of the tip housing from the inner wall surface of the front-end unit.

5. The vehicular indoor temperature sensor according to claim 4, wherein the cut portion is formed in a ‘U’ shape, and a width is formed to be ⅕ to ½ of a diameter of the front-end unit of the sensor housing.

6. The vehicular indoor temperature sensor according to claim 5, wherein the cut portion is formed to be larger than the front-end lower portion of the sensor housing facing the lower end portion of the rear body of the tip housing, toward a center along the length direction.

7. The vehicular indoor temperature sensor according to claim 6, further comprising a second temperature sensor installed on the PCB substrate to sense temperature and compensate for a difference of temperature between the tip sensor unit and the PCB substrate.

8. The vehicular indoor temperature sensor according to claim 1, wherein the front-end lower portion of the sensor housing, where the cut portion is formed, includes a lowest point in a direction of gravity, at a front end of the sensor housing when the sensor housing is disposed.

9. A vehicular indoor temperature sensor comprising:
a PCB substrate; and
a tip sensor unit connected to a front side of the PCB substrate and including a first temperature sensor for detecting a temperature of the outer surface of one side of a tip housing, and a solar radiation sensor for sensing an amount of solar radiation incident on the outer surface of the one side of the tip housing, wherein
a second temperature sensor for compensating for a difference of temperature between the tip sensor unit and the PCB substrate is installed on the PCB substrate.

10. The vehicular indoor temperature sensor according to claim 9, wherein a conformal coating layer is formed on at least a portion of the PCB substrate to prevent infiltration of flowing-in moisture.
